(19) United States
(12) Patent Application Publication
(10) Pub. No.: US 2015/0371242 A1
(43) Pub. Date: Dec. 24, 2015

(54) SYSTEMS AND METHODS FOR PRIME PRODUCT FORECASTING

(71) Applicant: Caterpillar Inc., Peoria, IL (US)

(72) Inventors: Sridhar RAMASWAMY, Naperville, IL (US); Mark Carl RICHARDSON, Peoria, IL (US); James Robert MASON, Bloomington, IL (US); Kenneth Dale GRAY, Peoria, IL (US); Bhargvendra TRIPATHI, Peoria, IL (US); Sangjeong NAM, Savoy, IL (US)

(73) Assignee: Caterpillar Inc.

(21) Appl. No.: 14/311,682

(22) Filed: Jun. 23, 2014

(51) Int. Cl. G06Q 30/02

(52) U.S. Cl. CPC G06Q 30/0202

(57) ABSTRACT

Systems and methods are disclosed for forecasting future sales of a prime product. The system includes at least one processor configured with instructions to collect historical sales data of the prime product, collect historical telematics data from one or more machines that were sold as the prime product, and collect historical econometric data relevant to the prime product. The at least one processor also generates a group of candidate predictors from the historical telematics data and the historical econometric data, select predictors from the group of candidate predictors, and establish a forecasting model representing a relationship between the selected predictors and the historical sales data of the prime product. The at least one processor forecasts future sales of the prime product by using the established forecasting model.

### TECHNICAL FIELD

This disclosure relates generally to forecasting methods and, more particularly, to forecast sales of prime products using telematics data and econometric data.

### BACKGROUND

Organizations, such as those that produce, buy, sell, and/or lease machines as their prime products, may desire to forecast information concerning the machines. For example, an organization that manufactures one or more machines may desire to accurately forecast demands for the machines, in order to plan the organization's production schedule for the machines, and/or a supplier's delivery schedule for subcomponents of the machines.

U.S. Patent Publication No. 2013/0204662 (the '662 publication) to Grichnik et al. is directed to systems and methods for forecasting using modulated data. In particular, the '662 publication discloses a method including collecting historical data associated with characteristics of a target item, and modulating the historical data with a modulator signal. The method also includes determining an intermediary function that includes one or more variables, and implementing a genetic algorithm to determine a data value for each of the variables of the intermediary function. Moreover, the method includes solving the intermediary function using the data values determined by the genetic algorithm, and generating a forecast function representing forecasted characteristics of the target item by subtracting the modulator signal from the intermediary function. While the '662 publication may help to generate accurate representation of the historical characteristics of the target item, the forecasts generated by the '662 system may not always take into account machine utilization information or econometric information, which may affect the future characteristics (e.g., sales, demand, etc.) of the target item.

The disclosed methods and systems are directed to solve one or more of the problems set forth above and/or other problems of the prior art.

### SUMMARY

In one aspect, the present disclosure is directed to a computer system for forecasting future sales of a prime product. The computer system includes at least one processor configured with instructions to collect historical sales data of the prime product, collect historical telematics data from one or more machines that were sold as the prime product, and collect historical econometric data relevant to the prime product. The at least one processor is also configured with instructions to generate a group of candidate predictors from the historical telematics data and the historical econometric data, select predictors from the group of candidate predictors, and establish a forecasting model representing a relationship between the selected predictors and the historical sales data of the prime product. The at least one processor is further configured with instructions to forecast future sales of the prime product by using the established forecasting model.

In another aspect, the present disclosure is directed to a method for forecasting future sales of a prime product. The method includes collecting historical sales data of the prime product, collecting historical telematics data from one or more machines that were sold as the prime product, and collecting historical econometric data relevant to the prime product. The method also includes generating a group of candidate predictors from the historical telematics data and the historical econometric data, selecting predictors from the group of candidate predictors, and establishing a forecasting model representing a relationship between the selected predictors and the historical sales data of the prime product. The method further includes forecasting future sales of the prime product by using the established forecasting model.

In yet another aspect, the present disclosure is directed to a non-transitory computer-readable storage device storing instructions for forecasting future sales of a prime product. The instructions cause one or more computer processors to perform operations including collecting historical sales data of the prime product, collecting historical telematics data from one or more machines that were sold as the prime product, and collecting historical econometric data relevant to the prime product. The instructions also cause the one or more computer processors to perform operations including generating a group of candidate predictors from the historical telematics data and the historical econometric data, selecting predictors from the group of candidate predictors, and establishing a forecasting model representing a relationship between the selected predictors and the historical sales data of the prime product. The instructions further cause the one or more computer processors to perform operations including forecasting future sales of the prime product by using the established forecasting model.

### BRIEF DESCRIPTION OF THE DRAWINGS

FIG. 1 illustrates an exemplary system environment in which a prime product forecasting system consistent with a disclosed embodiment may be implemented.

FIG. 2 illustrates an exemplary prime product forecasting system consistent with a disclosed embodiment.

FIG. 3 illustrates a flowchart of a process of forecasting future sales of a prime product, according to a disclosed embodiment.

FIG. 4 illustrates an exemplary historical sales data of a prime product in an exemplary geographic region.

FIGS. 5-7 illustrate flowcharts of a process of data preparation on historical telematics data, according to a disclosed embodiment.

FIG. 8 illustrates exemplary leading predictors of a candidate predictor, according to a disclosed embodiment.

FIG. 9 illustrates exemplary monthly seasonality indices for prime product sales, according to a disclosed embodiment.

FIG. 10 illustrates a flowchart of a process of selecting predictors from a group of candidate predictors, according to a disclosed embodiment.

FIG. 11 illustrates a flowchart of a process of establishing a forecasting model, according to a disclosed embodiment.

FIG. 12 illustrates a flowchart of a process of forecasting future sales, according to a disclosed embodiment.

FIG. 13 illustrates actual historical data of an exemplary predictor and fitted data produced according to a disclosed embodiment.

FIG. 14 illustrates actual historical data of an exemplary predictor and future data of the predictor generated according to a disclosed embodiment.

FIG. 15 illustrates actual historical sales data, fitted historical sales data, and forecasted future sales data generated according to a disclosed embodiment.

### DETAILED DESCRIPTION

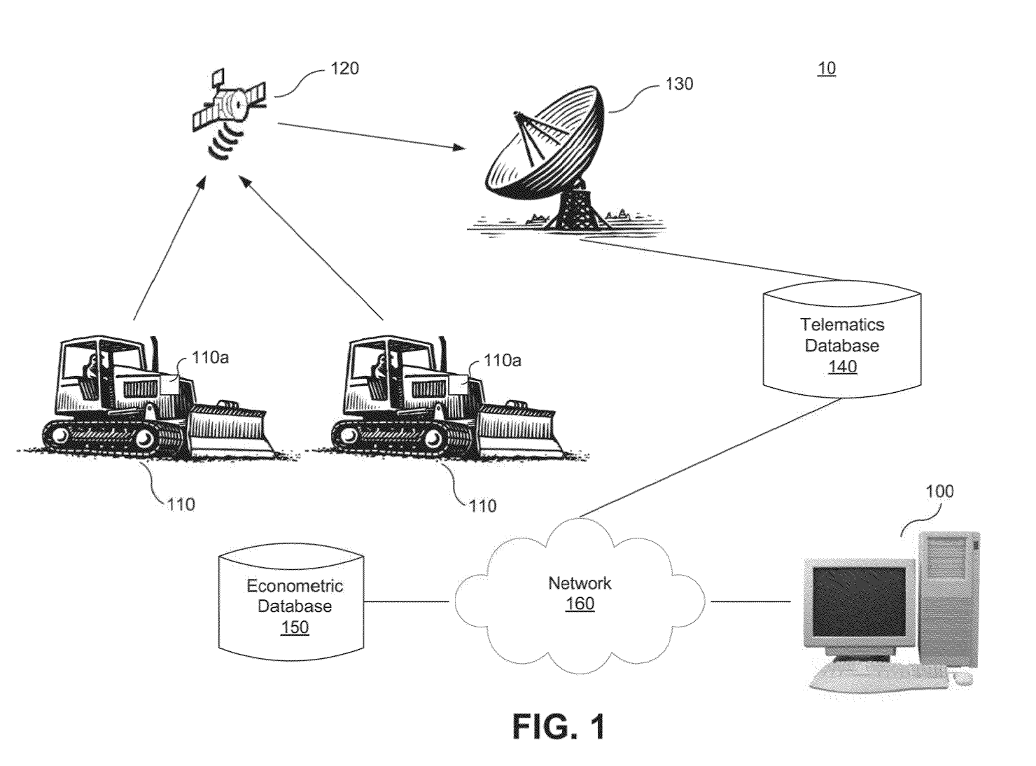

FIG. 1 illustrates an exemplary system environment 10 in which a prime product forecasting system 100 consistent with a disclosed embodiment may be implemented. A prime product, as used herein, may represent any type of physical good that is designed, developed, manufactured, and/or delivered by a source, such as, for example, a manufacturer or a distributor. For example, a prime product may be a machine, a piece of equipment, a vehicle, an aircraft, a locomotive, etc., manufactured by a business entity. The machine may be a fixed machine or mobile machine that may perform some type of operation associated with a particular industry, such as mining, construction, farming, etc. and operate between or within work environments (e.g., a construction site, mine site, power plant, etc.). Although the forecasting processes discussed below will be described with respect to a machine, those skilled in the art will appreciate that the following description may apply to any type of prime product.

System environment 10 may include a plurality of machines 110, a satellite 120, a satellite base station 130, a telematics database 140, an econometric database 150, and a network 160. Prime product forecasting system 100 may be connected to telematics database 140 and econometric database 150 via network 160.

As discussed previously, machine 110 may be a fixed machine or mobile machine that may perform some type of operation associated with a particular industry, such as mining, construction, farming, etc. and operate between or within work environments (e.g., a construction site, mine site, power plant, etc.). A non-limiting example of a fixed machine includes an engine system operating in a plant or off-shore environment (e.g., off-shore drilling platform). Non-limiting examples of mobile machines include commercial machines, such as trucks, cranes, earth moving vehicles, mining vehicles, backhoes, material handling equipment, farming equipment, marine vessels, on-highway vehicles, or any other type of movable machine that operates in a work environment.

Each machine 110 may include a telematics data unit 110a attached thereto. Telematics data unit 110a may monitor telematics data of the corresponding machine 110, and may periodically transmit the telematics data to telematics database 140 via satellite 120 and satellite base station 130. The telematics data may represent location, utilization, and condition of the corresponding machine 110. Non-limiting examples of the telematics data of machine 110 include runtime, fuel consumption, and idle time. Although not illustrated in FIG. 1, telematics data unit 110a may transmit the telematics data to telematics database 140 via other telecommunication links, such as cellular towers.

Telematics database 140 may be configured to store the telematics data received from the plurality of machines 110. In some embodiments, the telematics data stored in telematics database 140 may be classified into different categories based on distinct geographical regions where machines 110 are located. For example, the telematics data may be classified into Asia Pacific region telematics data associated with machines located in the Asia Pacific region, North America telematics data associated with machines located in the North America region, Latin America telematics data associated with machines located in the Latin America region, and Africa and Middle East telematics data associated with machines located in the Africa and Middle East region.

Econometric database 150 may be configured to store econometric data collected from different economic institutions or government agencies. The econometric data may represent the global economic outlook, or the economic outlook of a given geographic region. Since the geographic regions differ extensively on Macro economic factors, prime product forecasting system 100 may forecast future sales and/or demands for one or more prime products in a certain geographic region based on economic data that are exclusive representations of the econometric outlook of that geographic region. The econometric data may include monthly industrial production indices of various industries such as, for example, coal mining, natural gas, electric gas, metal ore mining, nonmetallic mining, etc. The econometric data may also include monthly average prices of various raw materials such as, for example, crude oil, copper, gasoline, etc. The econometric data may further include various construction indicators such as, for example, monthly total construction spending, monthly residential construction spending, monthly non-residential construction spending, monthly architectural building index, number of housing starts per month, construction price index per month, number of housing permit, etc. The econometric data may also include other econometric indicators such as production manager index, institute supply management (ISM) composite indicator, consumer pricing index, gross domestic product, seasonality factor, and number of sale days per month.

Although in the embodiment illustrated in FIG. 1, system environment 10 includes only one telematics database 140 and one econometric database 150, those skilled in the art will appreciate that more than one database may be included in system environment 10. For example, the econometric data including various industrial production indices may be stored in one database, and the econometric data including various construction indicators may be stored in another database.

Although in the embodiment illustrated in FIG. 1, telematics database 140 and econometric database 150 are located outside of prime product forecasting system 100, those skilled in the art will appreciate that telematics database 140 and econometric database 150 may be included inside prime product forecasting system 100.

Network 160 shown in FIG. 1 may include any one of or combination of wired or wireless networks. For example, network 160 may include wired networks such as twisted pair wire, coaxial cable, optical fiber, and/or a digital network. Likewise, network 160 may include any wireless networks such as RFID, microwave or cellular networks or wireless networks employing, e.g., IEEE 802.11 or Bluetooth protocols. Additionally, network 160 may be integrated into any local area network, wide area network, campus area network, or the Internet.

Prime product forecasting system 100 may include one or more hardware and/or software components configured to display, collect, store, analyze, distribute, report, process, record, and/or sort information related to prime product forecasting. In one embodiment, prime product forecasting system 100 may be configured to collect telematics data from telematics database 140, and collect econometric data from econometric database 150, via network 160. In another embodiment, a user may manually collect econometric data from various renowned economic institutions, and manually input the collected econometric data into prime product forecasting system 100. Prime product forecasting system 100 may be configured to forecast future sales and/or demands for various prime products based on the collected telematics data econometric data.

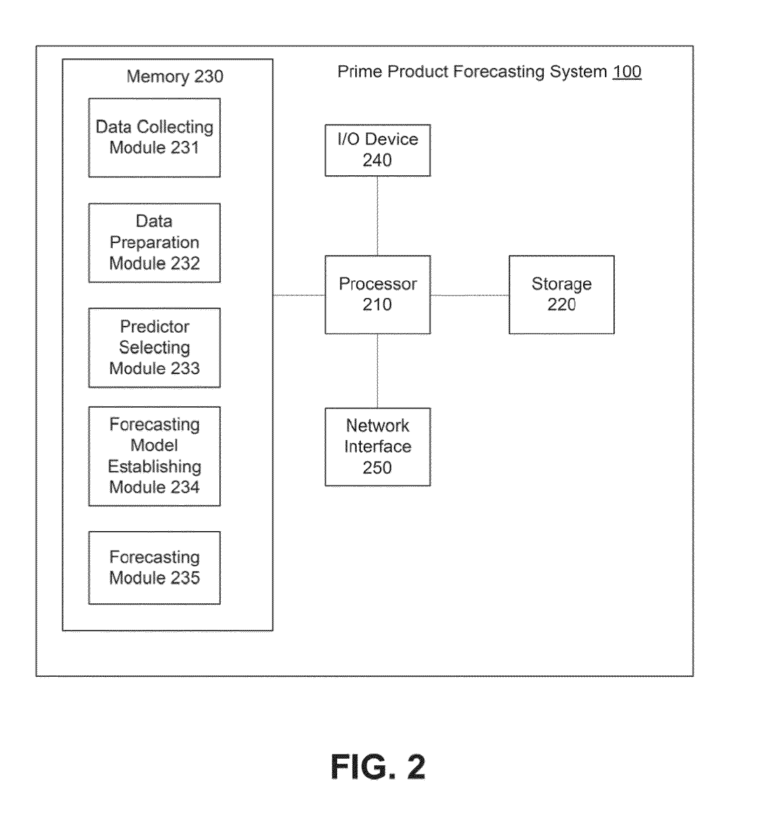

FIG. 2 illustrates an exemplary prime product forecasting system 100 (hereinafter referred to as “system 100”) consistent with a disclosed embodiment. System 100 may include one or more of a processor 210, a storage unit 220, a memory 230, an input/output (I/O) device 240, and a network interface 250. System 100 may be connected via network 160 to telematics database 140, econometric database 150, or other databases. In addition, system 100 may be connected via network 160 to one or more client terminals located remotely from system 100.

System 100 may be a server, client, mainframe, desktop, laptop, network computer, workstation, personal digital assistant (PDA), tablet PC, or the like. In one embodiment, system 100 may be a computer located in a manufacturing facility and may be configured to receive and process telematics data and econometric data associated with one or more prime products, and forecast future sales and/or demands for the one or more prime products based on the telematics data and econometric data. In addition, one or more constituent components of system 100 may be co-located with a prime product supplier, a prime product manufacturing facility, or a prime product distributing facility for supplying, manufacturing, or distributing the prime products.

Processor 210 may include one or more processing devices. For example, processor 210 may include one or more microprocessors from the Pentium™ or Xeon™ family manufactured by Intel™, the Turion™ family manufactured by AMD™, or any other type of processors. As shown in FIG. 2, processor 210 may be communicatively coupled to storage unit 220, memory 230, I/O device 240, and network interface 250. Processor 210 may be configured to execute computer program instructions to perform various processes and method consistent with certain disclosed embodiments. In one exemplary embodiment, computer program instructions may be stored in storage unit 220, and may be loaded into memory 230 for execution by processor 210.

Storage unit 220 may include a volatile or non-volatile, magnetic, semiconductor, tape, optical, removable, nonremovable, or other type of storage device or computer-readable medium. Storage unit 220 may store programs and/or other information that may be used by system 100. In one embodiment, storage unit 220 may store the telematics data and the econometrics data collected from telematics database 140 and econometrics database 150.

Memory 230 may include one or more storage devices configured to store information used by system 100 to perform certain functions related to the disclosed embodiments. In one embodiment, memory 230 may include one or more modules (e.g., collections of one or more programs or subprograms) loaded from storage unit 220 or elsewhere that perform (i.e., that when executed by processor 210, enable processor 210 to perform) various procedures, operations, or processes consistent with the disclosed embodiment. For example, memory 230 may a data collecting module 231, a data preparation module 232, a predictor selecting module 233, a forecasting model establishing module 234, and forecasting module 235. Data collecting module 231 may enable processor 210 to collect historical telematics data and econometric data, and historical sales data related to a prime product. Data preparation module 232 may enable processor 210 to prepare a group of candidate predictors based on the collected data. In some embodiments, data preparation module 232 may also enable processor 210 to perform data cleaning on the collected data. Predictor selecting module 233 may enable processor 210 to select predictors from the group of candidate predictors. Forecasting model establishing module 234 may enable processor 210 to establish a forecasting model that represents a relationship between the selected predictors and the historical sales data. Forecasting module 235 may enable processor 210 to forecast future sales of the prime product based on the established forecasting model.

I/O device 240 may include one or more components configured to communication information associated with system 100. For example, I/O device 240 may include a console with an integrated keyboard and mouse to allow a user to input parameters associated with system 100 and/or data associated with prime product forecasting. I/O device 240 may include one or more displays or other peripheral devices, such as, for example, printers, cameras, microphones, speaker systems, electronic tablets, bar code readers, scanners, or any other suitable type of I/O device 240. For example, I/O device 240 may include a display that displays forecasted future demands for a product in a format chosen by a user, such as, for example, table, graph, etc.

Network interface 250 may include one or more components configured to transmit and receive data via network 160, such as, for example, one or more modulators, demodulators, multiplexers, de-multiplexers, network communication devices, wireless devices, antennas, modems, and any other type of device configured to enable data communication via any suitable communication network. Network interface 250 may also be configured to provide remote connectivity between processor 210, storage unit 220, memory 230, and I/O device 240, and a remote client terminal to collect, analyze, and distribute data or information associated with prime product forecasting.

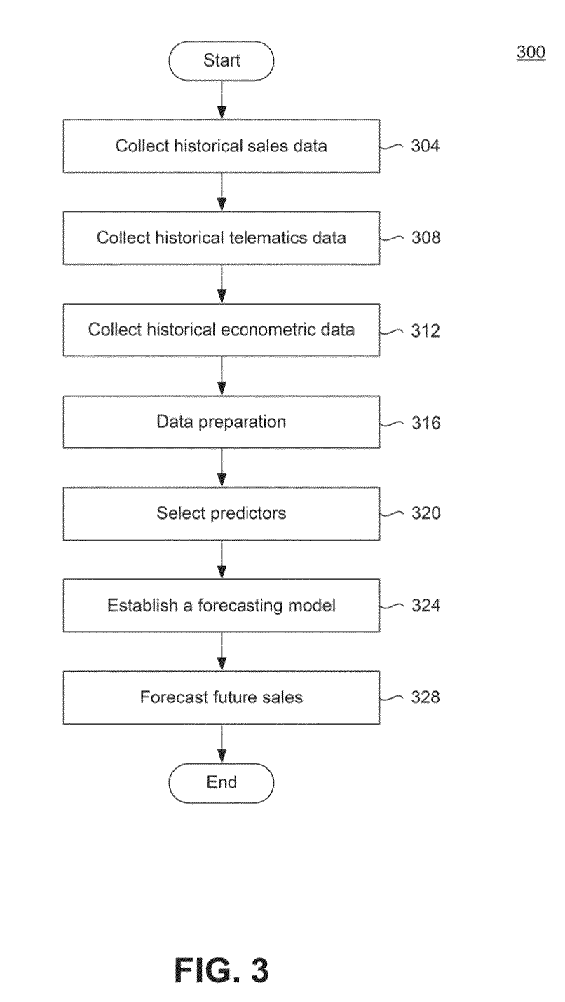

System 100 may be applicable to forecast future sales of any prime product. The operation of processor 210 in system 100 will now be described in connection with FIG. 3, which illustrates a flowchart of a process 300 of forecasting future sales or demands for a prime product by processor 210 according to a disclosed embodiment.

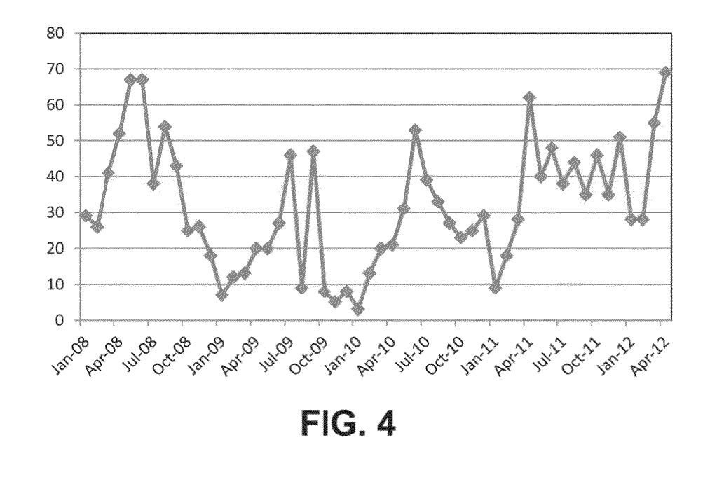

Referring to FIG. 3, processor 210 may first collect historical sales data of the prime product (step 304). For example, the historical sales data of the prime product may be time series data including the total income generated by sales of the prime product in each month over a historical period of time such as, for example, for the past five years. For another example, the historical sales data of the prime product may be time series data including the number of prime product sold each month over the historical period of time. FIG. 4 illustrates an exemplary historical sales data (number of units sold) of a prime product from January, 2008 to April, 2012 in an exemplary geographic region.

In some embodiments, processor 210 may collect historical sales data of the prime product over various geographic regions from, for example, a manufacturer, and store the collected data in a database external or internal of system 100. For forecasting future sales and/or demands for the prime product in a particular geographic region, processor 210 may extract historical sales and/or demands data of the prime product in the particular geographic region.

Processor 210 may also collect historical telematics data reported from telematics data units 110a of the plurality of machines 110 (step 308). The plurality of machines 110 may be previously sold or manufactured by a manufacture as the prime product to be forecasted. The historical telematics data of a reporting machine may include monthly service meter hours, monthly gallons of fuel consumed, monthly idle hours, etc., of the reporting machine over a historical period of time. The telematics data may be stored in telematics database 140. When processor 210 is configured to forecast the future sales and/or demands for the prime product in a particular geographic region, processor 210 may be configured to collect telematics data of machines that were originally sold as the prime product and are currently located in the particular geographic region. In some embodiments, the plurality of machines 110 may include rental machines (i.e., machines rented by end-customers) and non-rental machines (i.e., machines owned by end-customers). The machine utilization information included in the telematics data for the rental machines and the non-rental machines may have effect on the sales and/or demands for the prime product. Therefore, processor 210 may categorize the collected historical telematics data as rental data (i.e., historical telematics data reported from the rental machines) and non-rental data (i.e., historical telematics data reported from the non-rental machines). Processor 210 may analyze the rental data and non-rental data separately for forecasting future sales and/or demands of the prime product.

Processor 210 may further collect historical econometric data relevant to the prime product (step 312). For example, processor 210 may collect historical industrial production indices of the industry where the prime product (e.g., the machine) is currently employed. Processor 210 may also collect historical monthly average prices of the raw materials that are currently used by the prime product (e.g., the machine). In some embodiments, the econometric data may be pre-stored in econometric database 150, and processor 210 may be configured to collect the econometric data from econometric database 150. Alternatively, a user may collect the econometric data and manually input the econometric data into storage unit 220 of system 100.

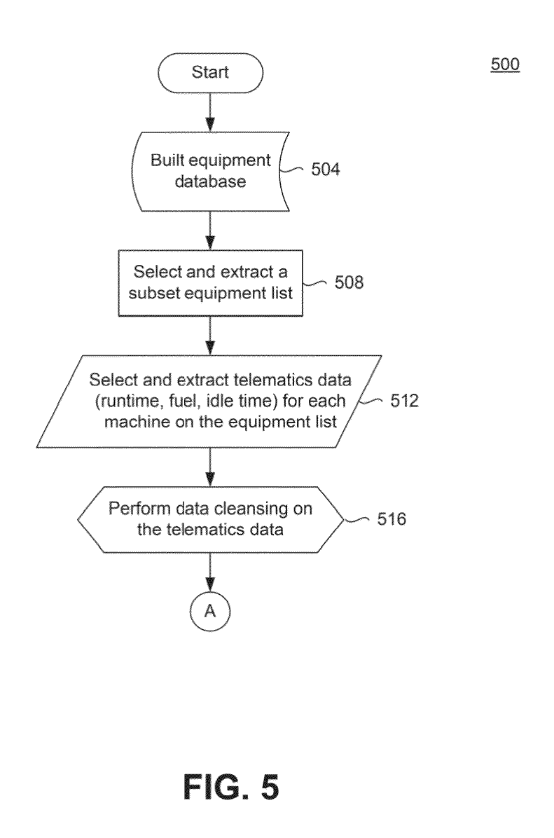

Processor 210 may preform data preparation on the collected historical telematics data and econometric data to generate a group of candidate predictors (step 316). FIGS. 5-7 illustrate flowcharts of a process 500 of data preparation on the historical telematics data, according to a disclosed embodiment.

Referring to FIG. 5, processor 210 may first build an equipment database (step 504). The equipment database may include information related to all of the machines that are/were manufactured by an organization as the prime product. For example, processor 210 may build the equipment database based on an existing marketing database associated with the organization that manufactures the machines. Processor 210 may build the equipment database by including identifiers of specific product group(s) and sales model(s) of the prime product, and excluding out-of-scope models.

Once the equipment database is built, processor 210 may select and extract a subset equipment list from the equipment database (step 508). The equipment list may include all of the machines that have been sold over a historical period of time as the prime product to be forecasted, and the product identifiers of these machines. Processor 210 may obtain the product identifiers from the equipment database. The equipment list may also include additional product attributes, as well as sales and territory information (e.g., the geographic region where the machine has been sold to) of each machine.

Processor 210 may select and extract telematics data for each machine on the equipment list (step 512). The telematics data may include records of machine runtime, fuel consumption, and idle time of each machine. Processor 210 may obtain these telematics data from telematics database 140.

Processor 210 may perform data cleansing on the extracted telematics data (step 516). The extracted telematics data may contain noise. For example, the data may be incomplete, corrupt, or inaccurate in certain months. Therefore, processor 210 may perform data cleansing on the extracted telematics data to identify incomplete, incorrect, inaccurate, irrelevant, duplicate, etc. portions of the data, and then replace, modify, or delete the portions of the data. Processor 210 may also correct the data format for the extracted telematics data.

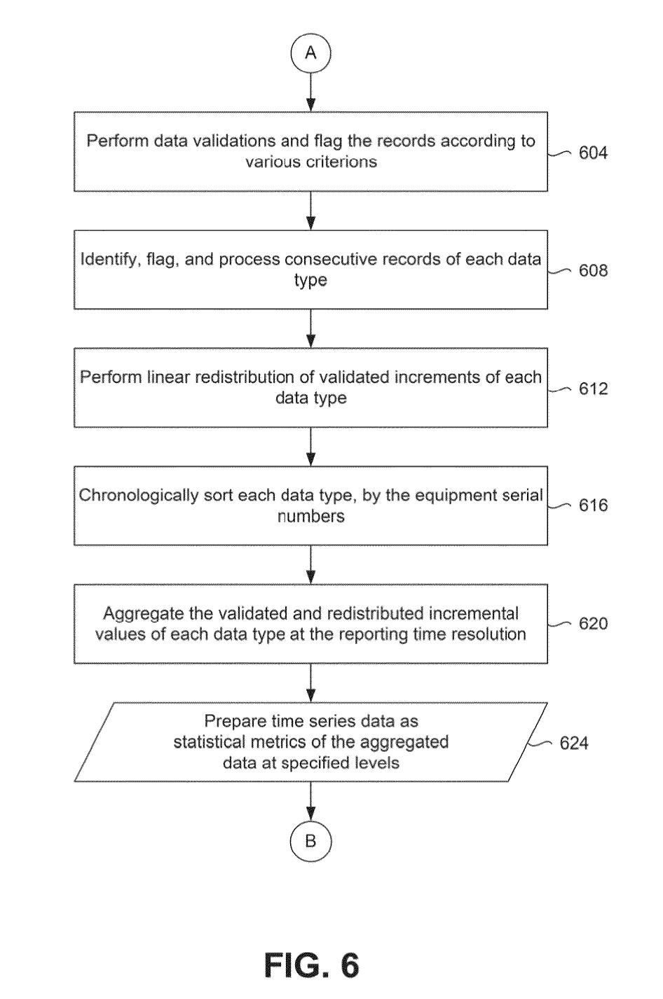

Referring to FIG. 6, once the telematics data is cleansed, processor 210 may perform data validation and flag the data record based on various criterions (step 604). One exemplary criterion may require that no data-points should precede the corresponding machine build date. Another exemplary criterion may require cumulative lifetime values to be consistent with the machine life. Another exemplary criterion may require that the gain of total runtime hours or idle hours is less than one unit per clock hour. [Inventors: Please confirm this criterion is correct.] Another exemplary criterion may require that a fuel consumption rate does not exceed theoretical limits for the specified products. Another exemplary criterion may require that corresponding data-points from different sources should be consistent. Another exemplary criterion may require validated increments in the cumulative lifetime values should fit the reporting time resolution. When processor 210 identifies data or portions of data that does not meet the various criterions, processor 210 may place one or more flags in different categories on the identified data or portions of data based on the type of criterion that the data does not meet. Different flags may represent different methods to be used for processing the data in the following steps.

Processor 210 may identify and flag consecutive records of each data type (runtime, fuel, or idle time), and process the consecutive records when the consecutive records do not meet various criterions (step 608). The consecutive records of each data type may span the boundaries of reporting time resolution, e.g., month, or day. Processor 210 may determine which kind of action to be used to process a particular consecutive record based on which criterion the consecutive record does not meet. For example, processor 210 may identify the consecutive records of fuel consumption of one machine, and may find that the fuel consumption boundary of the identified consecutive records is greater than a theoretical threshold value. Processor 210 may then determine to drop (i.e., remove) the identified consecutive records.

Processor 210 may perform linear redistribution of validated increments of each data type for flagged data (step 612). For example, some data may be flagged in step 604 because the data does not meet the criterion that requires validated increments in the cumulative lifetime values should fit the reporting time resolution. Processor 210 may then perform linear redistribution of validated increments across the time interval boundaries.

Processor 210 may then chronologically sort each data type, by the equipment serial numbers (step 616). Processor 210 may aggregate the validated and redistributed incremental values of each data type at the reporting time resolution, e.g., weekly, or monthly (step 620). Processor 210 may prepare time series data as statistical metrics of the aggregated data at specified levels, e.g. sales model (step 624). For example, processor 210 may calculate mean/median service meter hours, mean/median fuel consumption, and mean/median idle hours based on the aggregated data.

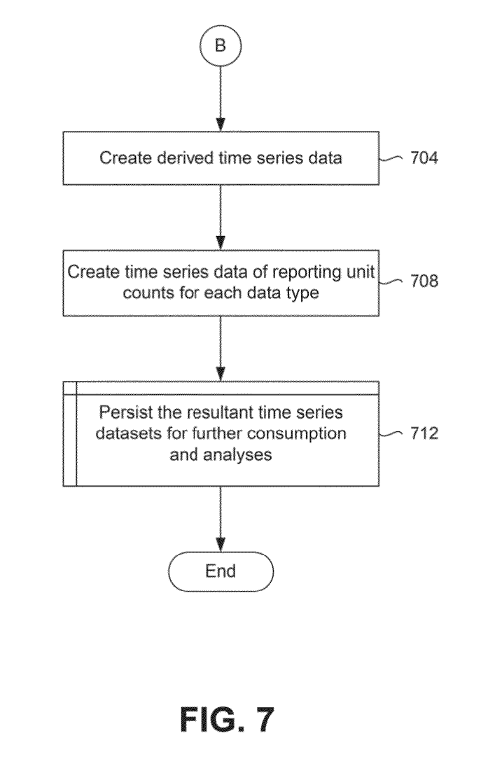

Referring to FIG. 7, processor 210 may create derived time series data based on the aggregated data (step 704). For example, processor 210 may create a time series of working hours represented by: Working Hours=Runtime Hours−Idle Hours. Processor 210 may create a time series of fuel burn rate represented by: Fuel Burn Rate=Fuel/Runtime. Processor 210 may also create a time series of service meter hours per gallon of fuel represented by: Hours/Gallon=Runtime/Fuel Consumed. Processor 210 may further create time series of mean/median working hours, mean gallon of fuel consumed per service meter hour, and mean service meter hours per gallon of fuel based on the aggregated data.

Processor 210 may create time series data of reporting unit counts for each data type (step 708). For example, processor 210 may summarize the number of machines that reports the runtime, fuel, idle time, at the reporting time resolution such as, for example, each month, quarter, etc.

Finally, processor 210 may persist all of the resultant time series datasets for further consumption and analyses (step 712). For example, processor 210 may save the time series dataset in a format that is appropriate for further processing. Each time series dataset constitute a candidate predictor. Then, processor 210 may end process 500 for data preparation.

Although in the exemplary embodiment described above with reference to FIGS. 5-7, processor 210 performed data preparation only on the telematics data, those skilled in the art would appreciate that processor 210 may perform a similar data preparation process on the econometric data. For example, processor 210 may perform data cleansing on the econometric data.

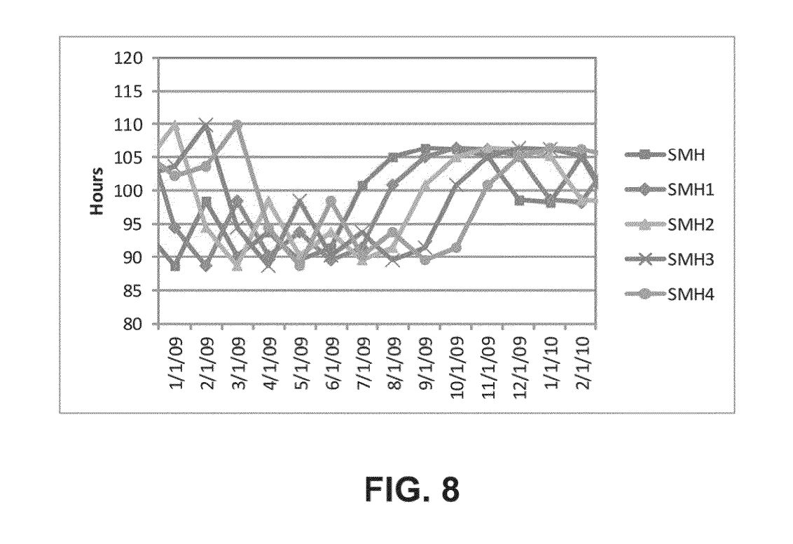

In some embodiments, during the data preparation process, processor 210 may also create leading predictors for each candidate predictor. This is because the telematics data and economics data may have an extended influence on the sales of the prime product. For example, an excessive service meter hour (SMH) reading of a machine in June may accelerate the depreciation process of the machine, and may require replacement of the machine three months later in September. That is, the SMH of the machine in June may affect the sales of the prime product (i.e., the machine) in September. Therefore, in order for system 100 to analyze such influence, one through twelve month leading predictors may be created for each candidate predictor. For example, processor 210 may create the one month leading predictor for a candidate predictor by moving down the data points by one month; processor 210 may create the two month leading predictor for the candidate predictor by moving down the data points by two months; processor 210 may create the three month leading predictor for the candidate predictor by moving down the data points by three months; and so on. FIG. 8 illustrates an exemplary service meter hour (SMH) as a candidate predictor, and its one through fourth month leading predictors SMH1, SMH2, SMH3, and SMH4. For example, the service meter hour of about 88 hours in January, 2009 of the SMH predictor is moved down to February, 2009 of SMH1, which is the one month leading predictor of the SMH predictor. For another example, the service meter hour of 105 hours in August, 2009 of the SMH predictor is moved down to December, 2009 of SMH4, which is the fourth month leading predictor of the SMH predictor. Processor 210 may add the created leading predictors into the group of candidate predictors.

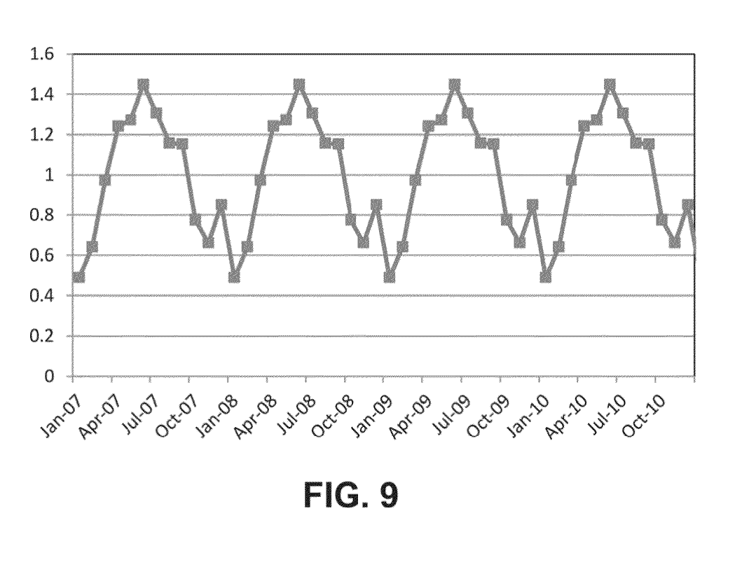

In some embodiments, during the data preparation process, processor 210 may also create monthly seasonality indices for prime product sales. The monthly seasonality indices represent the cyclic variation of the sales of the prime product over a historical period of time. For example, by analyzing the sales data of a prime product for the past five years, one may note that during the November through January time period, there may be a dip in the sales, and as the season progresses to summer, there may be clear peaks in the sales. Processor 210 may calculate the monthly seasonality indices based on the historical sales data over the past few years (e.g., five years). For example, a seasonality index for a month may be calculated as the average sales for that month over the past five years divided by average yearly sales. In some embodiments, processor 210 may create monthly seasonality indices for prime product sales in a particular geographic region of interest. FIG. 9 illustrates exemplary monthly seasonality indices for prime product sales, which may be created by processor 210. Processor 210 may add the created seasonality indices into the group of candidate predictors.

Referring back to FIG. 3, once processor 210 prepared the group of candidate predictors in the data preparation step 316, processor 210 may select predictors from the group of candidate predictors for further processing (step 320). At this point, the group of candidate predictors may include the cleansed and validated historical telematics and econometric data, the seasonality indices, and a period of (e.g., one to twelve) month leading predictors. Processor 210 may select the predictors from the candidate predictors by performing various analyses on these candidate predictors.

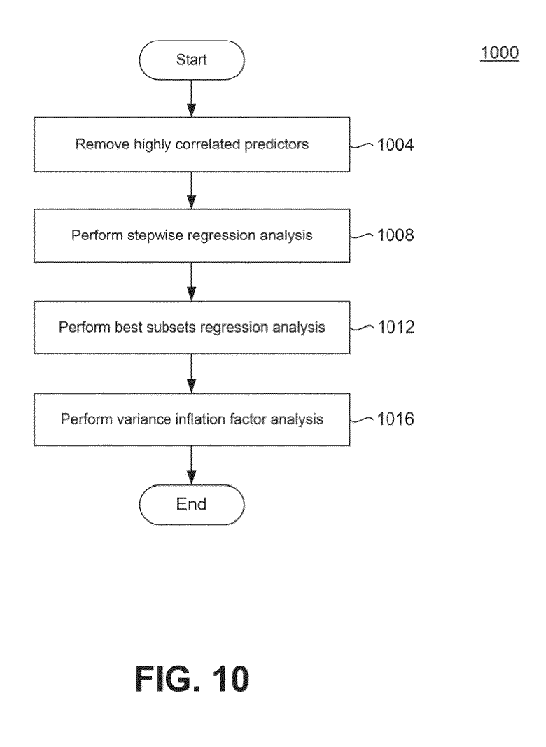

FIG. 10 illustrates a flowchart of a process 1000 of selecting predictors from the group of candidate predictors, according to a disclosed embodiment. During process 1000, processor 210 may remove highly correlated candidate predictors (step 1004). For example, processor 210 may analyze each pair of candidate predictors, and determine whether the candidate predictors are highly correlated with each other. If they are highly correlated, processor 210 may randomly remove one of the two highly correlated candidate predictors. Processor 210 may determine whether the two candidate predictors are highly correlated by calculating a Pearson correlation coefficient between the two candidate predictors, and compare the Pearson correlation coefficient with a predetermined threshold value such as, for example, 0.9. When the Pearson correlation coefficient is greater than 0.9, processor 210 may determine that the two candidate predictors are highly correlated, and may then remove one of the two candidate predictors from the group of candidate predictors.

Processor 210 may also perform stepwise regression analysis on the group of candidate predictors to select candidate predictors that are significant for prime product sales (step 1008). During the stepwise regression analysis, processor 210 may build a regression model from a subset of candidate predictors by entering and removing candidate predictors, in a stepwise manner, into the model until there is no reason to enter or remove any more candidate predictors into the model. For example, processor 210 may set an alpha significance level to no more than 0.05. Processor 210 may then perform the stepwise regression analysis until adding an additional candidate predictor into the subset of candidate predictor does not yield a probability value (P-value) below the alpha significance level. Processor 210 may select the final set of candidate predictors upon which the regression model is built, and remove the remaining candidate predictors from the group of candidate predictors.

Processor 210 may also perform best subsets regression analysis on the group of candidate predictors to select a subset of candidate predictors that capture the monthly sales variability (step 1012). During the best subsets regression analysis, processor 210 may select a predetermined number (e.g., four or five) of best subsets of candidate predictors that meet one or more objective criterion, such as having the largest adjusted R² value and/or the smallest mean squared error (MSE). For example, processor 210 may establish a plurality of possible regression models based on all of the possible combinations of the candidate predictors. The possible regression models may include linear regression models and non-linear regression models. The candidate predictors included in the regression models are not interacting with each other. For example, the regression models may not include products of two or more candidate predictors. Suppose there are n candidate predictors represented by x₁(t), x₂(t), . . . , xₙ(t). Processor 210 may establish a plurality of linear regression models based on each predictor, each linear regression model being represented by,

y(t)=A+Bxₐ(t)

where xₐ(t) is one of the n candidate predictors x₁(t), x₂(t), . . . , xₙ(t), A and B are constant values calculated by processor 210, and y(t) is the historical prime product sales data. Processor 210 may also establish a plurality of linear regression models based on a combination of two candidate predictors selected from the n candidate predictors, each linear regression model being represented by,

y(t)=A+Bxₐ(t)+Cx_{b}(t)

where xₐ(t) and x_{b}(t) are two candidate predictors selected from the n candidate predictors x₁(t), x₂(t), . . . , xₙ(t), and A, B, and C are constant values calculated by processor 210. Processor 210 may also establish a plurality of linear regression models based on combinations of three, four, . . . or n candidate predictors. Processor 210 may analyze each of the possible linear regression models, and select four (or five) best linear regression models that have the largest adjusted R² value and the smallest MSE. Processor 210 may select the four subsets of candidate predictors for building the four best linear regression models, respectively, as the four best subsets of candidate predictors. Processor 210 may remove the remaining candidate predictors from the group of candidate predictors.

Processor 210 may also perform variance inflation factor (VIF) analysis on the group of candidate predictors (step 1016). The VIF of a candidate predictors may represent the scale of correlation between the candidate predictor and all of the other candidate predictors in the group for a given regression model. During the VIF analysis, processor 210 may establish a first linear regression model based on all of the candidate predictors in the group, and calculate a VIF for each candidate predictor. Processor 210 may remove one or more candidate predictors from the group if their VIFs exceed a first VIF threshold value such as, for example, 5. Processor 210 may then establish another linear regression model based on the remaining candidate predictors, and remove one or more candidate predictors if their VIFs exceed a second VIF threshold value (e.g., 2) which is lower than the first VIF threshold value. Processor 210 may repeat the above-described process until all of the VIFs of the candidate predictors are below a VIF threshold value. Processor 210 may select the final candidate predictors, and remove the remaining ones from the group.

Once the VIF analysis is finished, processor 210 may set the selected candidate predictors as predictors for further processing, and may then terminate process 1000. Although in the embodiment illustrated in FIG. 10, the process for selecting predictors includes steps 1004, 1008, 1012, and 1016, the process is not so limited. That is, process 1000 may include one or more of steps 1004, 1008, 1012, and 1016. In addition, the process may include one or more additional analysis steps for selecting the predictors. Moreover, the sequence of steps 1004, 1008, 1012, and 1016 is not limited to the embodiment illustrated in FIG. 10. For example, step 1012 may be performed before step 1008, or step 1008 may be performed after step 1016.

Referring back to FIG. 3, once the predictors have been selected in step 320, processor 210 may establish a forecasting model based on the selected predictors (step 324). The established forecasting model represents a relationship between the selected predictors and the historical sales data for the prime product.

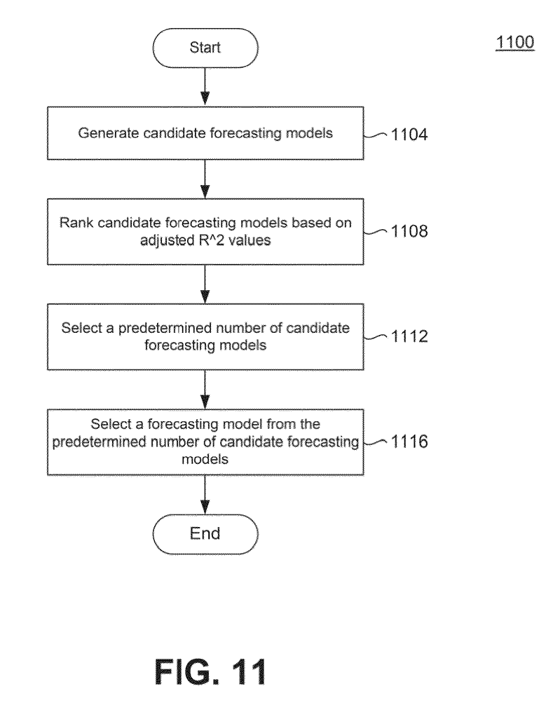

FIG. 11 illustrates a flowchart of a process 1100 of establishing the forecasting model, according to a disclosed embodiment. Processor 210 may generate a plurality of candidate forecasting models based on one or more of the selected predictors and the historical sales data of the prime product (step 1104). The candidate forecasting models may include one or more linear regression models and one or more non-linear regression models. For example, an exemplary linear regression model generated based on three predictors may be represented by,

y(t)=A+Bxₐ(t)+Cx_{b}(t)+Dx_{c}(t)

where xₐ(t), x_{b}(t), and x(t) are three predictors among n predictors x₁(t), x₂(t), . . . , xₙ(t), A, B, C, and D are constant values calculated by processor 210, and y(t) represents the sales or demands of the prime product. An exemplary non-linear regression generated based on three predictors may be represented by,

y(t)=A+Bxₐ^{α}(t)+Cx_{b}^{β}(t)+Dx_{c}^{γ}(t)

where xₐ(t), x_{b}(t), and x_{c}(t) are three predictors among n predictors x₁(t), x₂(t), . . . , xₙ(t), and A, B, C, D, α, β, γ are constant values calculated by processor 210.

Processor 210 may generate the plurality of candidate forecasting models by employing a Lazy Evaluation Algorithm for Production Systems (LEAPS) algorithm. Processor 210 may calculate an adjusted R² value for each candidate forecasting model, and rank the candidate forecasting models based on the adjusted R² values (step 1108). Processor 210 may select a predetermined number (e.g., 30) of candidate forecasting models that have the highest adjusted R² values among the plurality of candidate forecasting models (step 1112). Processor 210 may then select a forecasting model from the predetermined number of candidate forecasting models based on one or more criterions (step 1116). For example, processor 210 may select the forecasting model based on a statistical significance factor of each of the predictors in the candidate forecasting models. Processor 210 may also select the forecasting model based on one or more of a probability value (i.e., P-value), a fixation index (i.e., F-statistics value), and a residual standard error of each candidate forecasting model. In some embodiments, processor 210 may present at least one of the probability values, the fixation indices, or the residual standard errors of the candidate forecasting models on a display screen, such that a user may intelligently evaluate these values and select the forecasting model that has the optimum condition. The selected forecasting model may be a linear regression model or a non-linear regression model having a subset of predictors.

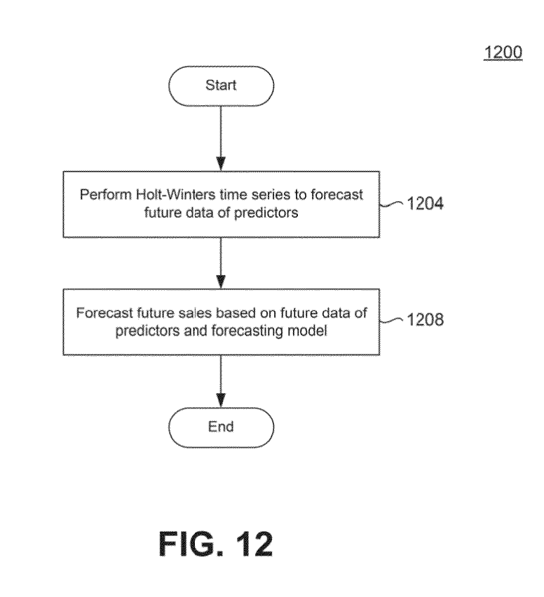

Referring back to FIG. 3, once the forecasting model has been established in step 324, processor 210 may proceed to forecast future sales and/or demands by using the forecasting model (step 328). FIG. 12 illustrates a flowchart of a process 1200 of forecasting future sales, according to a disclosed embodiment.

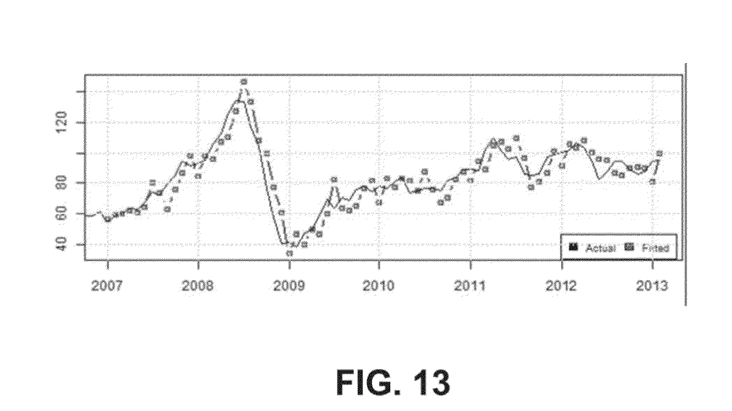

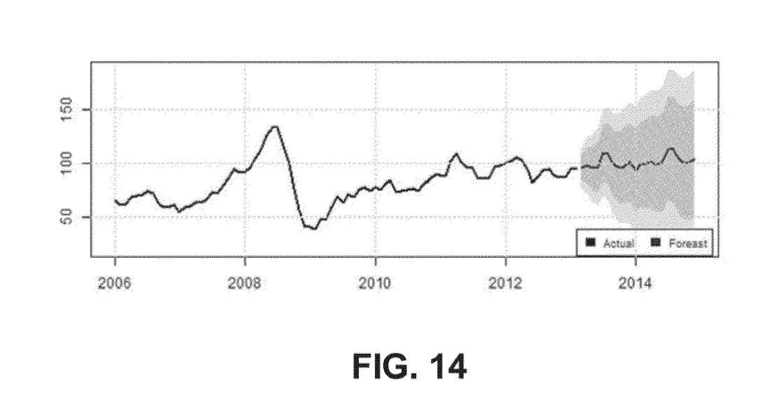

In process 1200, processor 210 may first forecast future data of each one of the predictors included in the forecasting model (step 1204). For example, processor 210 may employ a Holt-Winters method for establishing a fitting equation for each of the predictors, based on the historical data of the predictor and the monthly seasonality indices. Processor 210 may employ other process or algorithm for forecasting the future data of each predictor. FIG. 13 illustrates the actual historical data of an exemplary predictor and the fitted data produced by a fitting equation established by processor 210 using the Holt-Winters method. Once the fitting equation is established, processor 210 may then extend the fitting equation to the desired period in the future to forecast the future data of the predictor. FIG. 14 illustrates the actual historical data of the exemplary predictor and the future data of the predictor generated by extending the fitting equation to the future period.

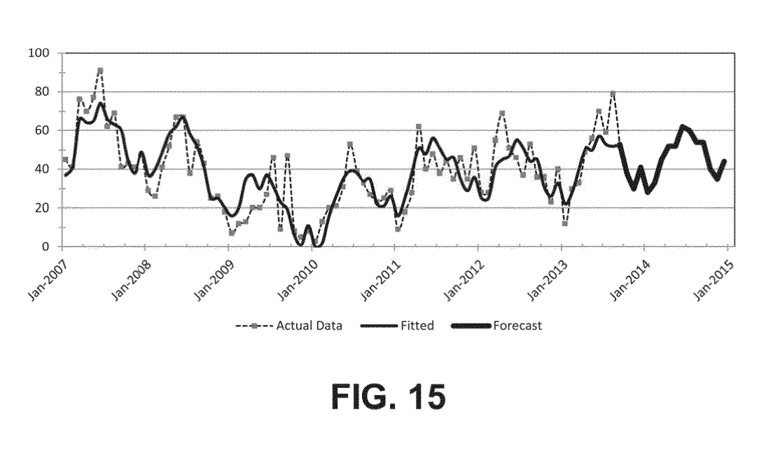

Processor 210 may then forecast the future sales of the prime product over a future period of time based on the future data of the predictors and the forecasting model (step 1208). The future sales of the prime product may be time series data including the number of prime products that might be demanded by customers each month over the future period of time. Alternatively, the future sales of the prime product may be time series data including the forecasted sales income generated by selling the prime product over the future period of time. FIG. 15 is a graph showing the actual historical sales data, the fitted historical sales data generated by the forecasting model based on the historical data of the predictors, and the forecasted future sales data generated by the forecasting model based on the future data of the predictors. Processor may then terminate the forecasting process 1200.

In some embodiments, processor 210 may employ a commercially available statistical software program such as Minitab by Minitab, INC., State College, Pa., for performing the various analyses in the method.

### INDUSTRIAL APPLICABILITY

Methods, systems, and articles of manufacture consistent with features related to the disclosed embodiments allow a system to forecast sales of various prime products based on telematics data and econometric data associated with the prime products. These methods and systems may be applied to any prime product.

Methods and systems consistent with certain embodiments utilize telematics data and econometric data to product forecast data for a prime product. The forecasting process may be performed periodically, for example, weekly, bi-weekly, monthly, quarterly, yearly.

Methods and systems consistent with certain embodiments uses advanced statistical techniques to forecast future sales based on various historical telematics data and econometric data. The methods and systems allow for accurately forecasting of future sales which is adapted for economic fluctuations, and proactively plan for inventory management of prime products. The forecast generated by the methods and systems would eventually improve the product sales, reduce excess inventory, and improve voice of customer, through improved On-Time-Delivery. Better customer satisfaction will lead to increased sales.

It will be apparent to those skilled in the art that various modifications and variations can be made to the disclosed prime product forecasting system. Other embodiments will be apparent to those skilled in the art from consideration of the specification and practice of the disclosed prime product forecasting system. It is intended that the specification and examples be considered as exemplary only, with a true scope being indicated by the following claims and their equivalents.

What is claimed is:

1. A computer system for forecasting future sales of a prime product, the computer system comprising:
at least one processor configured with instructions to:
collect historical sales data of the prime product;
collect historical telematics data from one or more machines that were sold as the prime product;
collect historical econometric data relevant to the prime product;
generate a group of candidate predictors from the historical telematics data and the historical econometric data;
select predictors from the group of candidate predictors;
establish a forecasting model representing a relationship between the selected predictors and the historical sales data of the prime product; and
forecast future sales of the prime product by using the established forecasting model.

2. The computer system of claim 1, wherein, in the step of generating the group of candidate predictors from the historical telematics data and the historical econometric data, the at least one processor is further configured to:
perform data cleansing on the historical telematics data and the historical econometric data.

3. The computer system of claim 2, wherein, in the step of generating the group of candidate predictors from the historical telematics data and the historical econometric data, the at least one processor is further configured to:
perform data validation on the cleansed data.

4. The computer system of claim 1, wherein, in the step of generating the group of candidate predictors from the historical telematics data and the historical econometric data, the at least one processor is further configured to:
create seasonality indices for prime product sales based on the historical sales data of the prime product; and
add the created seasonality indices into the group of candidate predictors.

5. The computer system of claim 1, wherein, in the step of generating the group of candidate predictors from the historical telematics data and the historical econometric data, the at least one processor is further configured to:
create leading predictors for each of the candidate predictors; and
add the created leading predictors into the group of candidate predictors.

6. The computer system of claim 1, wherein, in the step of selecting the predictors from the group of candidate predictors, the at least one processor is configured to:
remove highly correlated candidate predictors;
perform stepwise regression analysis on the candidate predictors;
perform best subsets analysis on the candidate predictors; and
perform variance influence factor analysis on the candidate predictors.

7. The computer system of claim 1, wherein, in the step of establishing the forecasting model, the at least one processor is configured to:
generate a plurality of candidate forecasting models based on the selected predictors by performing a Lazy Evaluation Algorithm for Production Systems (LEAPS) algorithm; and
select the forecasting model from the plurality of candidate forecasting model based on at least one of a probability value, a fixation index, or a residual standard error of each candidate forecasting model.

8. The computer system of claim 1, wherein, in the step of forecasting sales of the prime product, the at least one processor is configured to:
forecast future data of each predictor included the forecasting model; and
forecast the future sales by using the established forecasting model based on the future data of each predictor.

9. The computer system of claim 1, wherein the historical telematics data includes at least one of service meter hours, idle hours, working hours, service meter hours per gallon of fuel, or number of machines reporting telematics data.

10. The computer system of claim 1, wherein the historical econometric data includes at least one of an industrial production index, a construction indictor, or an econometric indictor.

11. A method for forecasting future sales of a prime product, the method comprising the following operations performed by at least one processor:
collecting historical sales data of the prime product;
collecting historical telematics data from one or more machines that were sold as the prime product;
collecting historical econometric data relevant to the prime product;
generating a group of candidate predictors from the historical telematics data and the historical econometric data;
selecting predictors from the group of candidate predictors;
establishing a forecasting model representing a relationship between the selected predictors and the historical sales data of the prime product; and
forecasting future sales of the prime product by using the established forecasting model.

12. The method of claim 11, further including:
performing data cleansing on the historical telematics data and the historical econometric data.

13. The method of claim 12, further including:
performing data validation on the cleansed data.

14. The method of claim 11, further including:
creating seasonality indices for prime product sales based on the historical sales data of the prime product; and
adding the created seasonality indices into the group of candidate predictors.

15. The method of claim 11, further including:
creating leading predictors for each of the candidate predictors; and
adding the created leading predictors into the group of candidate predictors.

16. The method of claim 11, wherein the step of selecting predictors from the group of candidate predictors including:
remove highly correlated candidate predictors;
perform stepwise regression analysis on the candidate predictors;
perform best subsets analysis on the candidate predictors; and
perform variance influence factor analysis on the candidate predictors.

17. The method of claim 11, wherein the step of establishing the forecasting model including:
generate a plurality of candidate forecasting models based on the selected predictors by performing a Lazy Evaluation Algorithm for Production Systems (LEAPS) algorithm; and
select the forecasting model from the plurality of candidate forecasting model based on at least one of a probability value, a fixation index, or a residual standard error of each candidate forecasting model.

18. The method of claim 11, wherein the step of forecasting sales of the prime product including:
forecasting future data of each predictor included the forecasting model; and
forecasting the future sales by using the established forecasting model based on the future data of each predictor.

19. The method of claim 11, wherein,
the historical telematics data includes at least one of service meter hours, idle hours, working hours, service meter hours per gallon of fuel, or number of machines reporting telematics data, and
the historical econometric data includes at least one of monthly industrial production indices of various industries, monthly average prices of various raw materials, or construction indicators.

20. A non-transitory computer-readable storage device storing instructions for forecasting future sales of a prime product, the instructions causing one or more computer processors to perform operations comprising:
collecting historical sales data of the prime product;
collecting historical telematics data from one or more machines that were sold as the prime product;
collecting historical econometric data relevant to the prime product;
generating a group of candidate predictors from the historical telematics data and the historical econometric data;
selecting predictors from the group of candidate predictors;
establishing a forecasting model representing a relationship between the selected predictors and the historical sales data of the prime product; and
forecasting future sales of the prime product by using the established forecasting model.
